(19) United States
(12) Patent Application Publication
(10) Pub. No.: US 2014/0366813 A1
(43) Pub. Date: Dec. 18, 2014

(54) SECURITY ANIMAL LEASH

(71) Applicant: Faye Annette Condit, San Ramon, CA (US)

(72) Inventor: Faye Annette Condit, San Ramon, CA (US)

(21) Appl. No.: 14/449,123

(22) Filed: Jul. 31, 2014

Related U.S. Application Data
(60) Provisional application No. 61/861,271, filed on Aug. 1, 2013.

(51) Int. Cl. A01K 27/00

(52) U.S. Cl. CPC A01K 27/003
USPC 119/795

(57) ABSTRACT

Disclosed is an Animal Security Leash comprising a pre-cut length of leash material folded over and secured to create a first loop end and a swivel hook loop end, with a plurality of loop security points at ascertainable distances with a swivel hook secured in a swivel hook loop between a swivel hook security point and the swivel hook loop end. The Animal Security Leash may be looped around an object and then looped through itself around to create a shorter fixed leash. A user may also grasp the Animal Security Leash between any of the plurality of loop security points and have as much comfort and control as though holding a loop end of a typical leash.

### CROSS-REFERENCE TO RELATED APPLICATION

This application claims the benefit of priority of U.S. Provisional Patent Application 61/861271 filed Aug. 1, 2013 and titled “Sadie's 8 in 1 Security Leach,” the disclosure of which is incorporated by reference.

### BACKGROUND OF THE INVENTION

1. Field of Invention

The invention relates generally to the field of animal leashes and specifically to adjustable length animal leashes.

2. Description of Related Art

Animal leashes provide handlers with control of an animal, and safety of other people, and other animals. Fixed length leashes are suitable for many uses, but there are times when a handler wants both to allow a longer leash at times, and yet have to gain quick and close control of the animal.

### SUMMARY OF THE INVENTION

Embodiments are directed to an apparatus of an Animal Security Leash comprising a leash material (205) having a pre-cut length (210) with a first end (215) and a second end (220), with the leash material (205) folded in approximately half to comprise a first loop end (225) and a swivel hook loop end (230), with the first end (215) and the second end (220) adjacently overlapping an ascertainable distance (235) from the first loop end (225), with a swivel hook (240) threaded onto the pre-cut length (210) of the leash material (205) and positioned near the swivel hook loop end (230), with a first loop security point (245) at the ascertainable distance (235) and comprising a triple layer (250) of the leash material (205) formed through an affixed overlap of the first end (215), with the second end (220) between the first end (215) and a designated portion (255) of the pre-cut length (210) of the leash material (205) near the ascertainable distance (235), with a plurality of leash loops (310, 320, 330, 340, 350, 360) each having a designated length (375) separated by one of a plurality of loop security points (315, 325, 335, 345, 355) fabricated through an affixed overlap of the pre-cut length (210) of the leash material (205), with the swivel hook (240) secured in a swivel hook loop (370) between a swivel hook security point (365) and the swivel hook loop end (230).

In some embodiments, the plurality of loop security points (310, 320, 330, 340, 350, 360) comprise an affixed overlap of the pre-cut length (210) of the leash material (205) secured by a stitching through the pre-cut length (210) of the leash material (205)..

In some embodiments, the plurality of loop security points (310, 320, 330, 340, 350, 360) comprise an affixed overlap of the pre-cut length (210) of the leash material (205) secured by a mechanical fastener through the pre-cut length (210) of the leash material (205).

In some embodiments, the plurality of loop security points comprise an affixed overlap of the pre-cut length (210) of the leash material (205) secured by a chemical fastening of the pre-cut length (210) of the leash material (205).

In some embodiments, the plurality of loop security points comprise an affixed overlap of the pre-cut length (210) of the leash material (205) secured by a thermal fastening of the pre-cut length (210) of the leash material (205).

In some embodiments, the ascertainable distance (235) is approximately six to twelve inches.

In some embodiments, the designated length (375) is approximately six to twelve inches.

### BRIEF DESCRIPTION OF THE DRAWINGS

FIG. 1 shows an exemplary Security Animal Leash (100).

FIG. 2A, 2B, 2C, 2D and 2E show an exemplary Security Animal Leash (200) in various stages and details.

FIG. 3 shows an exemplary Security Animal Leash (300).

FIG. 4 shows an exemplary Security Animal Leash (400).

FIG. 5 shows an exemplary Security Animal Leash (500).

### DETAILED DESCRIPTION OF THE INVENTION

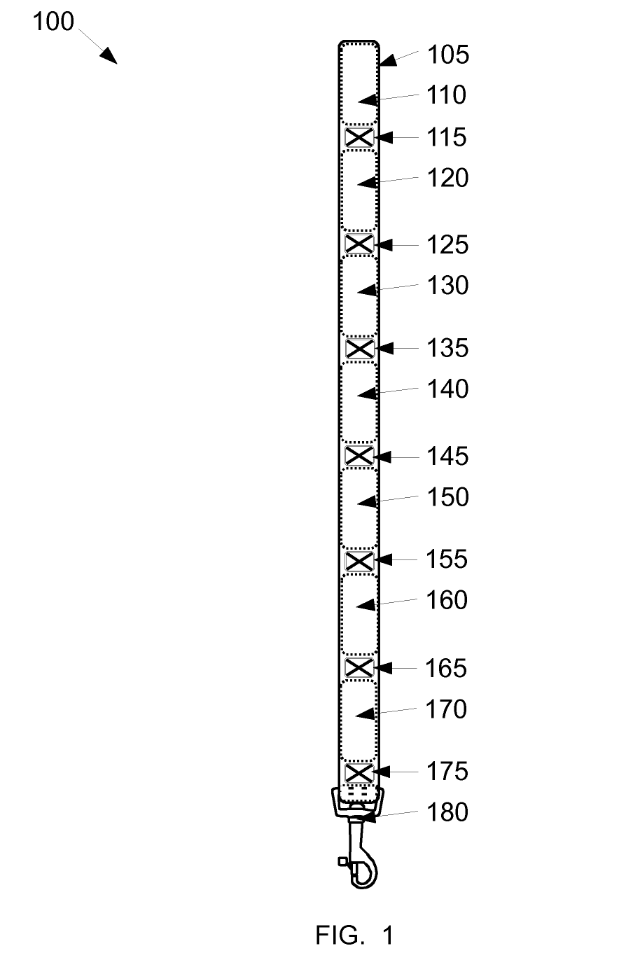

FIG. 1 shows an exemplary Security Animal Leash (100).

Shown in FIG. 1 are a leash material (105) with a plurality of leash loops and a plurality of security points, including a first loop (110), a first security point (115), a second loop (120), a second security point (125), a third loop (130), a third security point (135), a fourth loop (140), a fourth security point (145), a fifth loop (150), a fifth security point (155), a six loop (160), a six security point (165), a seventh loop (170), a swivel security point (175), and a swivel hook (180).

The dotted lines in this drawing represent that loops are present between layers of the leash material (105).

The leash material (105) provides the physical connection between a handler and the animal. The leash material (105) may be any length and of any material that when completely and properly assembled, provides a suitable length and strength for handing the animal to be handled.

The leash material (105) may be made of web nylon for many animals. Web nylon is available in rolls of many widths and lengths, making it suitable for creating short or long Security Animal Leashes. Web nylon is also available in many colors which provides an array of aesthetic pleasing colors. Web nylon also available works wells for inter-looping the Security Animal Leash, as is discussed below.

The leash material (105) may be made of traditional leash materials, such as leather, which like web nylon, is available in many widths and lengths.

The leash material (105) could be made of metal, such as wire or chain, though these materials may be difficult for inter-looping the Security Animal Leash.

The first loop (110), the second loop (120), the third loop (130), the fourth loop (140), the fifth loop (150), the six loop (160), and the seventh loop (170) provide adjustable length hand grips for a handler. A handler may place a hand in the first loop (110) to give an animal a full leash length to freedom, or a handler may place a hand in any of the other loops to have closer control on the animal.

In some embodiments, the first loop (110), the second loop (120), the third loop (130), the fourth loop (140), the fifth loop (150), the six loop (160), and the seventh loop (170) are the same length.

In some embodiments, the first loop (110), the second loop (120), the third loop (130), the fourth loop (140), the fifth loop (150), the six loop (160), and the seventh loop (170) are different lengths.

The first loop (110), the second loop (120), the third loop (130), the fourth loop (140), the fifth loop (150), the six loop (160), the and seventh loop (170) may be made of leash material (105).

The first security point (115), the second security point (125), the third security point (135), the fourth security point (145), the fifth security point (155), the six security point (165), and the swivel security point (175) provide locations at which leash material (105) may be secured to separate one security point from another security point.

In some embodiments, the Security Animal Leash may have the first security point (115), second security point (125), the third security point (135), and the swivel security point (175).

In some embodiments, the Security Animal Leash may have the first security point (115), second security point (125), the third security point (135), the fourth security point (145), and the swivel security point (175).

In some embodiments, the Security Animal Leash may have the first security point (115), second security point (125), the third security point (135), the fourth security point (145), the fifth security point (155) and the swivel security point (175).

In some embodiments, the Security Animal Leash may have the first security point (115), second security point (125), the third security point (135), the fourth security point (145), the fifth security point (155), the six security point (165) and the swivel security point (175).

In some embodiments, the Security Animal Leash may have the first security point (115), second security point (125), the third security point (135), the fourth security point (145), the fifth security point (155), the six security point (165), and one or more additional security points, plus the swivel security point (175).

In some embodiments, the security points ((115), (125), (135), (145), (155), (165), and (175), etc.) may be fabricated with Leash material (105) stitched together.

In some embodiments, the security points ((115), (125), (135), (145), (155), (165), and (175), etc.) may be fabricated with Leash material (105) mechanically fastened together.

In some embodiments, the security points ((115), (125), (135), (145), (155), (165), and (175), etc.) may be fabricated with Leash material (105) chemically fastened together.

In some embodiments, the security points ((115), (125), (135), (145), (155), (165), and (175), etc.) may be fabricated with Leash material (105) thermally fastened together.

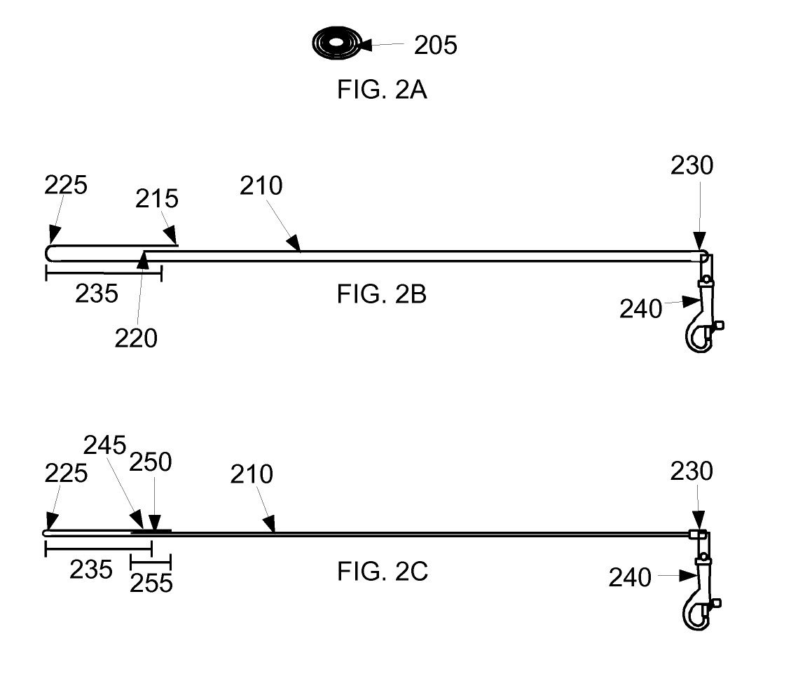

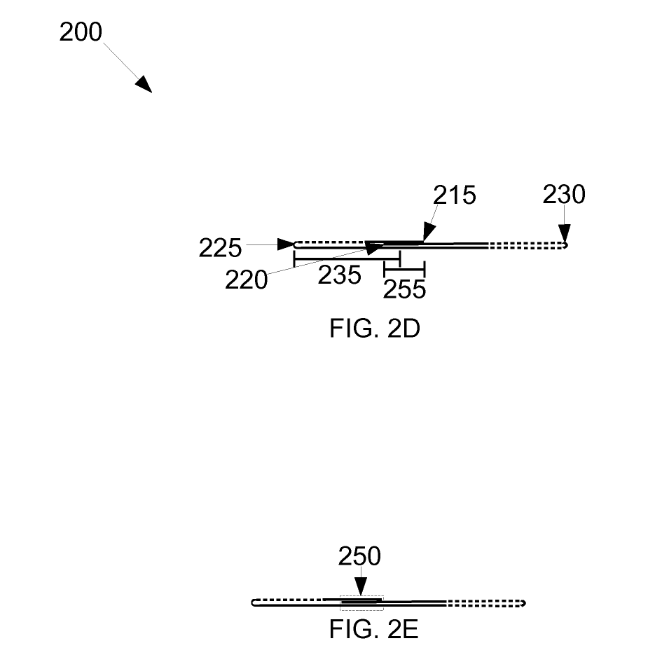

FIG. 2A, 2B, 2C. 2D and 2D show an exemplary Security Animal Leash (200) in various stages and details.

Shown in FIG. 2A is a representative roll of Leash material (205). Leash material (205) is also available is strips, which may also be used. Leash material (205) is then cut to the desired length, generally twice the length of the desired final Animal Security Leash.

Shown in FIG. 2B is a portion of the Animal Security Leash comprising a leash material (205) having a pre-cut length (210) with a first end (215) and a second end (220), with

the leash material (205) folded in approximately half to comprise a first loop end (225) and a swivel hook loop end (230), with the first end (215) and the second end (220) adjacently overlapping an ascertainable distance (235) from the first loop end (225), with a swivel hook (240) threaded onto the pre-cut length (210) of the leash material (205) and positioned near the swivel hook loop end (230).

A distinguishing feature of the Security Animal Leash is that the first end (215) and second end (220) of leash material (205) are wrapped such that the leash material (205) will form a continuous loop, rather than two or more separate and independent ends, as is typical with animal leashes, and with three layers of Leash material (205) forming the First security point (115) at a terminus of the first loop, which is often the loop held when walking animals.

FIG. 2C shows the portion of the Animal Security Leash shown in FIG. 2B with the distinction that the pre-cut length (210) of the leash material (205) has been compressed to form a triple layer (250) of the leash material (205) formed through an affixed overlap of the first end (215), with the second end (220) between the first end (215) and a designated portion (255) of the pre-cut length (210) of the leash material (205) near the ascertainable distance (235).

FIG. 2D shows a portion of FIG. 2C comprising a first loop security point (245) at the ascertainable distance (235) and comprising a triple layer (250) of the leash material (205).

FIG. 2E shows the triple layer (250) of the leash material (205) formed through an affixed overlap of the first end (215), with the second end (220) between the first end (215) and a designated portion (255) of the pre-cut length (210) of the leash material (205) near the ascertainable distance (235).

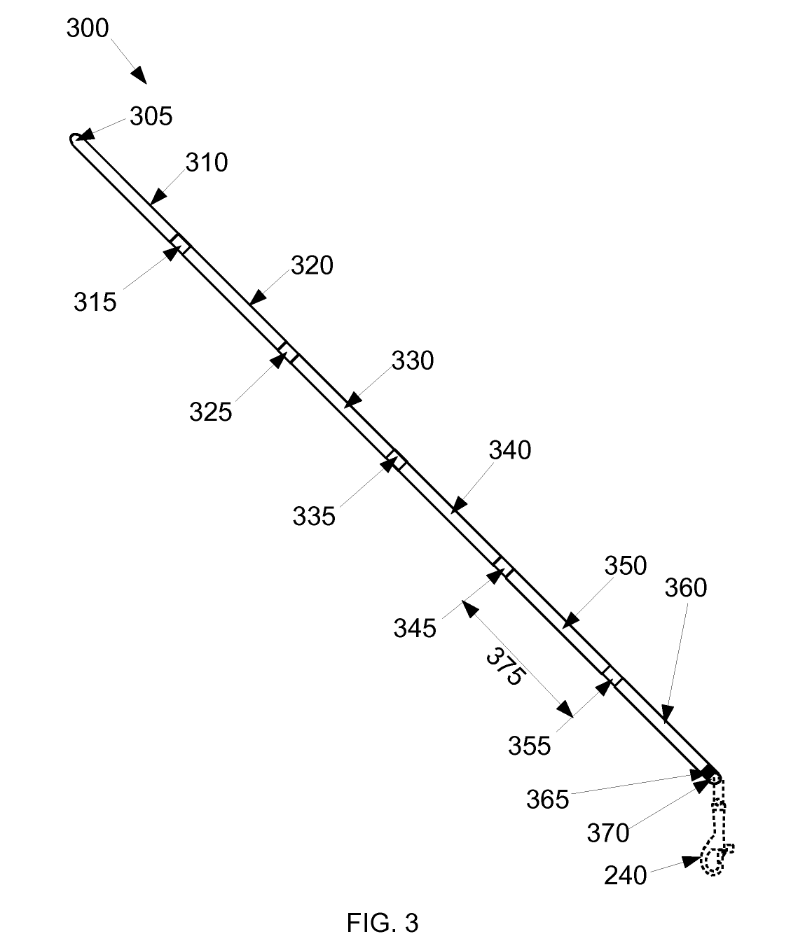

FIG. 3 shows an exemplary Security Animal Leash (300).

Shown in FIG. 3 is the assembled Security Animal Leash comprising a plurality of leash loops (310, 320, 330, 340, 350, 360) each having a designated length (375) separated by a loop security point fabricated through an affixed overlap of the pre-cut length (210) of the leash material (205) creating a plurality of loop security points (315, 325, 335, 345, 355), with the swivel hook (240) secured in a swivel hook loop (370) between a swivel hook security point (365) and the swivel hook loop end (230).

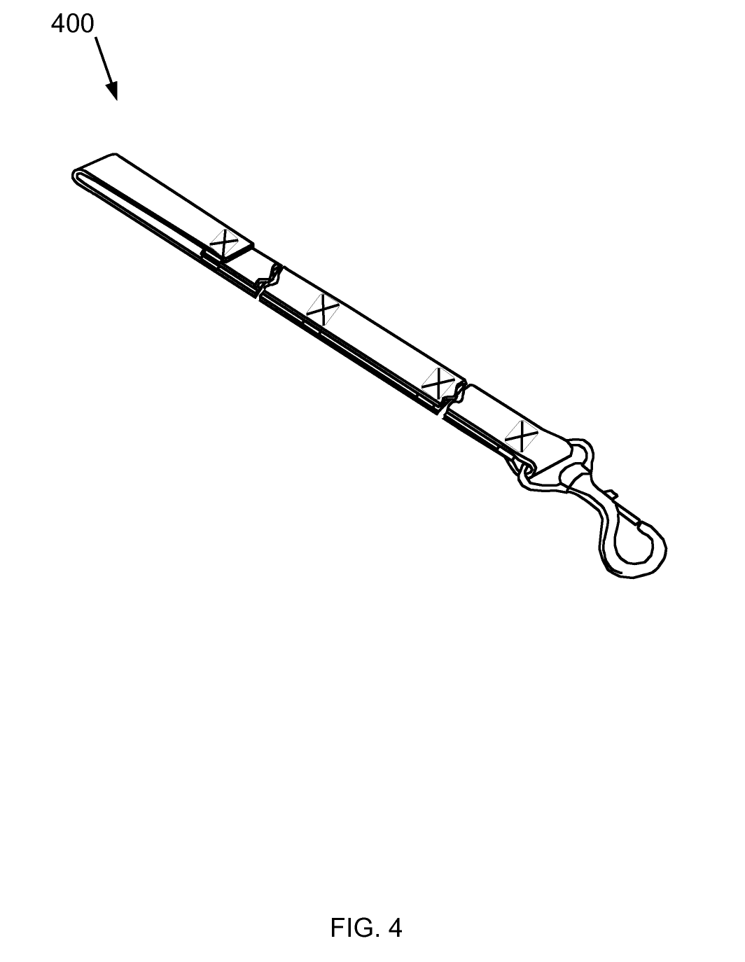

FIG. 4 shows an exemplary Security Animal Leash (400) wherein the plurality of loop security points comprise an affixed overlap of the pre-cut length (210) of the leash material (205) secured by a stitching through the pre-cut length (210) of the leash material (205).

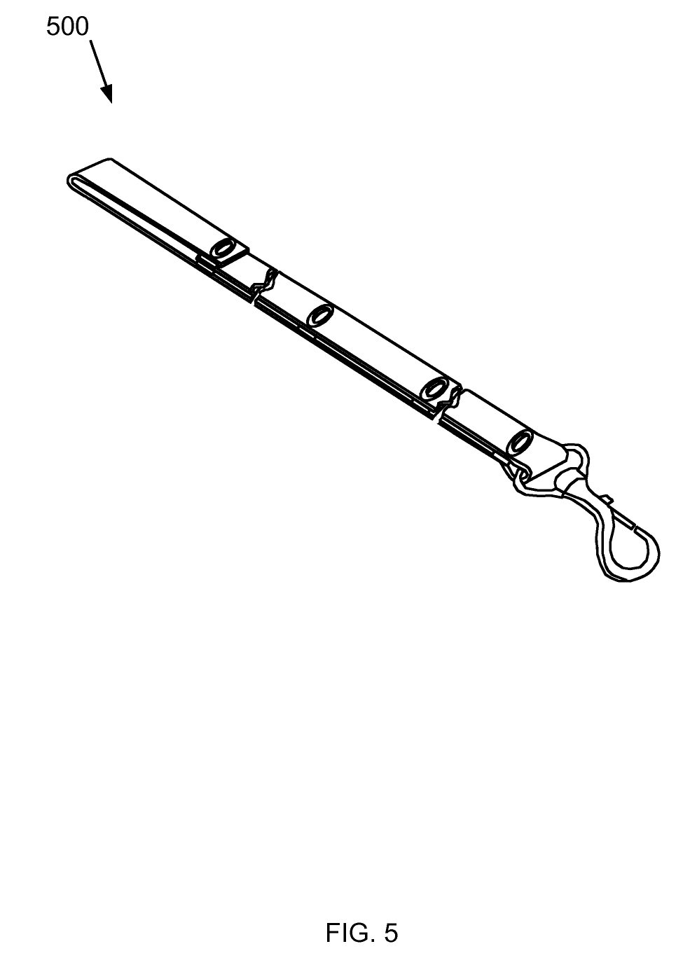

FIG. 5 shows an exemplary Security Animal Leash (500) The Animal Security Leash of claim 1 wherein the plurality of loop security points comprise an affixed overlap of the pre-cut length (210) of the leash material (205) secured by a mechanical fastener through the pre-cut length (210) of the leash material (205).

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this invention. It is realized that changes are possible within the scope of this invention and it is further intended that each structure or element recited in any of the claims is to be understood as referring to all equivalent structure or elements. The following claims are intended to cover the invention as broadly as possible in whatever form it may be used.

I claim:

1. An Animal Security Leash comprising:
a leash material (205) having a pre-cut length (210) with a first end (215) and a second end (220), with
the leash material (205) folded in approximately half to comprise a first loop end (225) and a swivel hook loop end (230), with
the first end (215) and the second end (220) adjacently overlapping an ascertainable distance (235) from the first loop end (225), with
a swivel hook (240) threaded onto the pre-cut length (210) of the leash material (205) and positioned near the swivel hook loop end (230), with
a first loop security point (245) at the ascertainable distance (235) and comprising a triple layer (250) of the leash material (205) formed through an affixed overlap of the first end (215), with the second end (220) between the first end (215) and a designated portion (255) of the pre-cut length (210) of the leash material (205) near the ascertainable distance (235), with
a plurality of leash loops (310, 320, 330, 340, 350, 360) each having a designated length (375) separated by one of a plurality of loop security points (315, 325, 335, 345, 355) fabricated through an affixed overlap of the pre-cut length (210) of the leash material (205), with
the swivel hook (240) secured in a swivel hook loop (370) between a swivel hook security point (365) and the swivel hook loop end (230).

2. The Animal Security Leash of claim 1 wherein the plurality of loop security points (310, 320, 330, 340, 350, 360) comprise an affixed overlap of the pre-cut length (210) of the leash material (205) secured by a stitching through the pre-cut length (210) of the leash material (205).

3. The Animal Security Leash of claim 1 wherein the plurality of loop security points (310, 320, 330, 340, 350, 360) comprise an affixed overlap of the pre-cut length (210) of the leash material (205) secured by a mechanical fastener through the pre-cut length (210) of the leash material (205).

4. The Animal Security Leash of claim 1 wherein the plurality of loop security points comprise an affixed overlap of the pre-cut length (210) of the leash material (205) secured by a chemical fastening of the pre-cut length (210) of the leash material (205).

5. The Animal Security Leash of claim 1 wherein the plurality of loop security points comprise an affixed overlap of the pre-cut length (210) of the leash material (205) secured by a thermal fastening of the pre-cut length (210) of the leash material (205).

6. The Animal Security Leash of claim 1 wherein the ascertainable distance (235) is approximately six to twelve inches.

7. The Animal Security Leash of claim 1 wherein the designated length (375) is approximately six to twelve inches.
